(19) United States
(12) Patent Application Publication
(10) Pub. No.: US 2006/0165003 A1
(43) Pub. Date: Jul. 27, 2006

(54) Method and apparatus for monitoring data routing over a network

(75) Inventor: Craig Partridge, East Lansing, MI (US)

Correspondence Address: FISH & NEAVE IP GROUP;ROPES & GRAY LLP, ONE INTERNATIONAL PLACE, BOSTON, MA, 02110-2624, US

(73) Assignee: BBNT Solutions LLC

(21) Appl. No.: 11/042,291

(22) Filed: Jan. 24, 2005

(51) Int. Cl. H04J 3/14; H04L 12/28

(52) U.S. Cl. 370/248; 370/351

(57) ABSTRACT

Systems and methods, inter alia, verify traffic flow consistency and audit compliance and adherence to routing protocols employed for carrying data over a computer network. To this end, the systems and methods include, in certain embodiments, devices and methods that monitor data flow across a network and select a data packet moving across the network. The devices and methods observe the route of the data packet as it travels across the network and determine from the observed route whether the data packet traversed the network according to an expected route. Deviations from the expected route are flagged and optionally corrective action is taken to remove from the network a device that is failing to comply with the routing protocol.

### FIELD OF THE INVENTION

The invention relates to, among other things, systems and methods for auditing how data is routed over a data network and for detecting abnormalities in routing protocols and device operation.

### BACKGROUND

Data networks and internetworks are essential today and are now integral parts of our economy, military, education systems and more. As internetworks can carry sensitive and important data, people are interested in knowing how data traffic moves through an internetwork. Historically, the way researchers have gotten information about data routing is to listen in on the routing protocols used in the network. The information learned from listening to the routing protocols is used to build a network map that indicates how data is forwarded through the network. Alternatively, some techniques generate probe packets that are sent into the network to trace the path these packets make.

Although these techniques can work well, a problem will arise when someone is trying to intentionally misdirect network traffic. In those cases, where someone has control over one or more routers, or other devices on the network, that person may use the control to selectively misdirect traffic. In such cases, the router or device can lie as to how its routing protocols work or are going to be used. These corrupted routers can also distinguish between probe packets and other traffic they are working on and give misinformation as to how the probe packets are going to be forwarded. In such cases, it is difficult if not impossible for the prior art techniques to determine how data is routed through the internetwork.

Accordingly, there is a need in the art for systems that are capable of auditing data traffic to detect events that indicate data traffic is being forwarded in an unexpected manner.

### SUMMARY OF THE INVENTION

The systems and methods described herein include, inter alia, systems and methods for verifying traffic flow consistency and for auditing compliance and adherence to routing protocols employed for carrying data over a computer network. To this end, the systems and methods include, in certain embodiments, devices and methods that monitor data flow across a network and select a data packet moving across the network. The devices and methods observe the route of the data packet as it travels across the network and determine from the observed route whether the data packet traversed the network according to an expected route. Deviations from the expected route are flagged and optionally corrective action is taken to remove, repair or avoid a network device or network devices that are failing to route data as advertised. The systems and methods described herein may be employed to audit the routing of any type of data packet, including VOIP data and data packets associated with a flow or stream that is understood to carry sensitive information, such as banking information or intelligence. The systems and methods may be employed to use auditing processes to monitor the compliance of a selected device on the network, or to monitor compliance of a selected portion of the network. Thus, the invention provides auditing tools that can monitor data flows and device compliance by viewing actual traffic routing over the network.

To this end, in one aspect, the invention provides methods for auditing how a network routes a data packet. Such methods may comprise the operations of identifying a data packet of interest, deriving from information provided by the network, an expected path that the data packet of interest is expected to follow through the network, using information recorded by devices in the network to observe the path the data packet of interest actually takes through the network, and comparing the observed path to the expected path. To this end, and in another aspect, the invention provides auditing systems that audit routing operations on a network that includes a plurality of routers transmitting data packets over the network. The system includes an auditing system for observing a route of a data packet carried over the network, and a router isolation system responsive to the auditing system for comparing an observed route of a data packet with an expected route for the data packet and identifying whether a non-compliant router has passed a data packet in violation of protocol.

In one embodiment, each router in the portion of the network being audited, includes a process for generating a hash representative of a data packet processed by that router. Any suitable technique may be employed for generating the hash, and in one particular practice, each router includes a process that determines a hash value over an immutable portion of a packet observed at an input port. The hash value is determined by taking an input block of data, such as a data packet, and processing it to obtain a numerical value that is unique for the given input data. Since the hash digest is effectively unique for each input block of data, it serves as a signature for the data over which it was computed. Optionally, the system may employ a filter that compresses a group of the individual hashes into a reduced size data set. This provides more efficient data recording for what can be a substantial volume of data traveling through the router. In one particular embodiment, the system employs a bloom filter that will hash a data packet several different ways to get several different hash values. The bloom filter uses the differences in the hash values to create a record of the data packet, which is more space efficient than recording the hash value itself.

In a further embodiment, the auditing system includes a query process for generating query messages that direct devices on the network to indicate whether they have observed a data packet of interest. To this end, the query message may direct routers, or devices that are tapping the network, to indicate whether they have passed or observed a data packet of interest. Optionally, the query message can direct the routers or other devices to provide their stored hash values to the auditing system so that the auditing system can process the stored hash values and determine which of the routers on the network, and which of the network paths, have carried the data packet of interest.

Other objects of the invention will, in part, be obvious, and, in part, be shown from the following description of the systems and methods shown herein.

### BRIEF DESCRIPTION OF THE DRAWINGS

The foregoing and other objects and advantages of the invention will be appreciated more fully from the following further description thereof, with reference to the accompanying drawings wherein;

FIG. 1 a network having a system for auditing data routing;

FIG. 2 depicts an example of a data packet having portions that can be selected for hashing;

FIG. 3 depicts a one example of a process for recording a data packet; and

FIG. 4 depicts are example of determining an observed route;

### DESCRIPTION OF THE ILLUSTRATED EMBODIMENTS

To provide an overall understanding of the invention, certain illustrative embodiments will now be described. However, it will be understood by one of ordinary skill in the art that the systems and methods described herein can be adapted and modified for other applications and that such additions and modifications will not depart from the scope hereof.

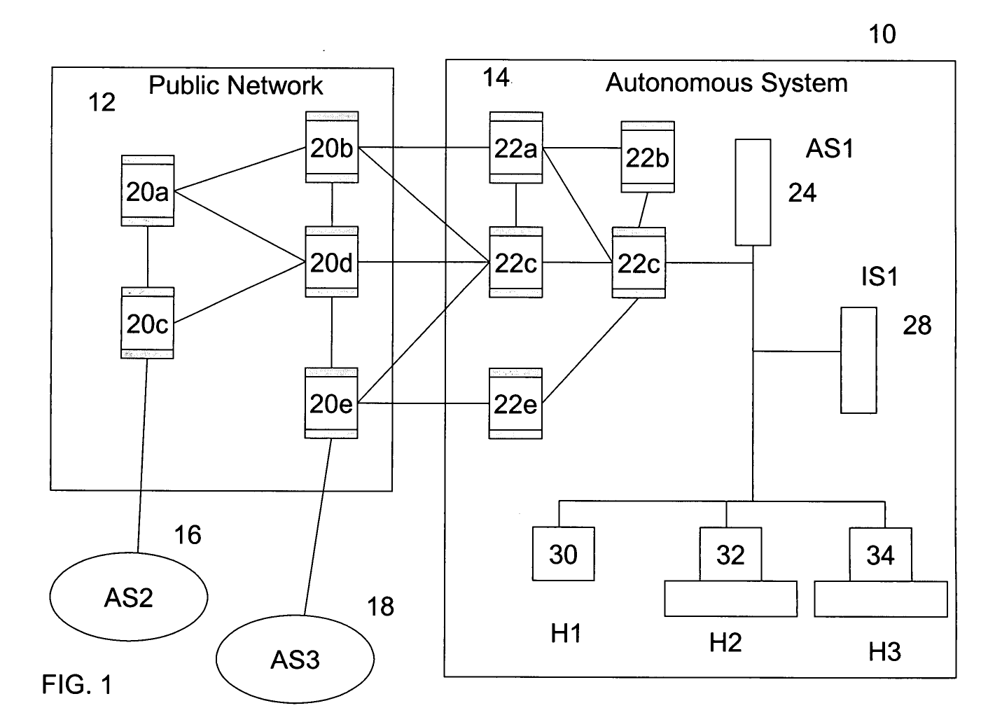

FIG. 1 depicts a first embodiment of a system for auditing data routing operations over a network. As will be discussed in more detail below, the auditing systems described herein can be used on any kind of data network where it would be beneficial to know how data is being routed over that network. In some applications, the auditing system will work as part of a local area network to collect information about how data is routed over that network, but it should be understood that the auditing system can be expanded to cover a wide area network, an internetwork or any portions of a network. Thus, the embodiments shown in the figures, including FIG. 1, are only provided as examples, and the invention itself can be extended or circumscribed as best suited to the application at hand.

More particularly, FIG. 1 depicts a network 10, that is meant to represent the Internet and to show that the Internet is made up, at least in part, of a collection of autonomous systems. To this end, FIG. 1 shows a network 10 that includes a public network 12 and number of autonomous systems 14, 16 and 18. For the purpose of this description, an autonomous system may be understood as simply a network or set of networks that have a common administrator and has been labeled as a distinct autonomous system. However, those of skill in the art will know that the term autonomous network is loosely defined, and that multiple autonomous systems may have the same administrator or a single autonomous system may be subdivided into multiple administrative domains. In any case, the term autonomous system is used to describe a portion of the Internet for which Internet users can consider there being one point of contact. The depiction of the autonomous systems 14, 16 and 18 is for illustration purposes only to show an example where an administrator having responsibility for a portion of the depicted network 10, may employ the invention over that portion to audit compliance of devices in that portion of the network. However, use of the invention is not limited to any particular type of network or sub-network. Moreover, it is clearly within the contemplation of the invention, that multiple autonomous systems could share compliance information and coordinate operations to audit routing compliance over larger portions of the network 10. For the purpose of illustration only autonomous system 14 is shown in detail. The public network 12 includes routers 20a-20e. The autonomous system 14 includes routers 22a-22e, an auditing server 24, an isolation server 28 and a plurality of host devices 30-34.

FIG. 1 illustrates an embodiment that may be used with an Internet Protocol (IP) network, although the invention will work with other network protocols. More particularly, FIG. 1 depicts the network 10 as broken into four general components, the public network 12, and the autonomous systems 14, 16 and 18. These component networks within FIG. 1 are connected by links carrying data traffic between the networks. Links may be comprised of wire, fiber optic cable, radio frequency (RF) transponders, or the like. In any case, the result is that the network 10 depicted in FIG. 1 is formed from a set of smaller networks that are interconnected to provide a large area network over which many different kinds of traffic can be carried to many different locations. Thus, data originating from or directed to any of the autonomous networks, may be rerouted across any of the paths shown in the network 10, including paths in any of the subnetworks.

The depicted public network 12 carries data traffic between the autonomous systems and comprises routers 20a-20e, and the links (shown as lines) that operatively couple the routers 20a-20e, and the links attaching to the autonomous systems 14, 16 and 18. The public network 12 may comprise computers external to the depicted autonomous systems as well as other components. The public network 12 is a publicly accessible data network that will carry data from any party and to any party and may be used by the public to access the autonomous networks 14-18.

The autonomous networks 14-18 may be local area networks, such as the local area networks used by a university, business, municipality or other entity. The routers and other devices in the autonomous network are typically, although not always, under the control and supervision of a network administrator. As such, the autonomous network may be modified as described herein to audit the data routing operations occurring over the autonomous network.

In this example, the autonomous network 14 has been modified to allow for auditing data routing operations. More specifically, the autonomous network 14 includes an auditing system that has several components, including the auditing server 24, the isolation server 28 and one or more network devices, such as the depicted routers 22a-22e, that have been modified to record information about the data packets traveling through the router. Thus, in this embodiment, the routers 22a-22e record information about which data packets have actually been processed by the router. This recorded information may be employed by the auditing server 24 to determine the actual path taken by a data packet of interest through the network.

The auditing server 24 includes a network tap that allows it to listen to the network and monitor data packets traveling across the links of the autonomous system 14. The auditing server 24 can passively monitor the network until it detects a data packet of interest. Auditing server 24 may then begin to audit the route taken by the packet through the autonomous network 14 to determine whether the network devices, including the routers 22a-22e are adhering to the proper and/or expected routing protocols. Accordingly, it can be seen that in this practice the auditing server 24 is observing actual data traffic over the autonomous network 14 and is selecting an actual data packet being carried over the network 14 for the purpose of auditing the routing procedures. In an optional practice, test packets may be used, and the auditing server 24 may generate a test packet for delivery over the autonomous network 14 and may monitor the routing processes employed to route the test packet. In one embodiment, the systems and methods described herein may generate data packets that have an expected path that travels through a device or a portion of the network of interest. The observed path of the data packet may be compared to the expected path, and in this way devices and sections of the network may be audited for compliance with the advertised routing procedures

However, in the present depicted embodiment, the auditing server 24 is observing and auditing actual data traffic and to that end, the auditing server 24 passively monitors data packets flowing over the network 14 until it finds a data packet of interest. The auditing server 24 may select a data packet at random, or may do so periodically or according to other criteria including criteria set by a network administrator. In certain embodiments, the auditing server 24 may select data packets that have been, or are expected to have been, recently handled by a particular device on the network 14, or the auditing server 24 may select data packets that have a particular source or destination. In any case, the auditing server 24 may audit the actual routing of any type of data packet, including VOIP data and data packets associated with a flow or stream that is understood to carry sensitive information, such as banking information or intelligence. To this end, the auditing server 24 may include a monitoring process that analyzes data packets as they pass the server 24 and will detect data packets that have characteristics associated with a VOIP transmission, or for detecting a data packet that is associated with a selected conversation of flow. To this end, the auditing server 24 may examine the header information of the packet, as well as characteristics of the traffic flow between a source and its end point. However, any suitable technique may be used without departing from the scope of the invention.

In any case, the data packet or packets of interest are selected. As discussed above, the autonomous network 14 includes devices, such as the routers 22a-22e, that collect information representative of the data packets that have traveled over the links of the network 14. In the network 14 depicted in FIG. 1, the routers 22a-22e have been modified to make a record of the data packets it has observed. To this end, the routers 22a-22e first store a representation of each packet it forwards. Any suitable representation or recording may be used, including a full copy of the data packet and optionally each recording may be time-stamped or provided with some other indicator of when the packet was observed. However, typically, a representation of a packet passed through the modified router will not be a copy of the entire packet, but rather it will be comprised of a portion of the packet or some unique value representative of the packet. Since modern routers can pass gigabits of data per second, and storing complete packets is not optimal. In contrast, storing a value that is representative of the contents of a packet uses memory in a much more efficient manner and still provides a value that may be employed to record that the data packet was observed by the device. By way of example, if incoming packets range in size from 256 bits to 1000 bits, a fixed width number may be computed across the bits making up a packet in a manner that allows the entire packet to be uniquely or least sufficiently, identified. To further illustrate the use of such representations, a 32-bit hash value, or digest, may be computed across each packet. Then, the digest may be stored in memory or the digest may be used as an index, or address, into memory. One such example of hash and digest processes that may be employed by the modified routers 22a-22e is described in Snoeren et al., Single-Packet IP Traceback, IEEE/ACM Trans. Net., vol. 10, no. 6, December 2002, pp. 721-34. As discussed therein, using the digest, or an index derived from the digest, results in efficient use of memory while still allowing each packet passing through a router to be identified. Thus, although the systems and methods described herein work with any suitable technique for deriving representations of packets, for brevity, the remaining discussion will use hash digests as representations of packets having passed through a participating router. However, it will be understood that the systems and methods described herein work with any storage technique that saves information about each packet in a space efficient manner, that can determine if a packet has not been observed, and that will respond in a predictable way when a packet has been observed.

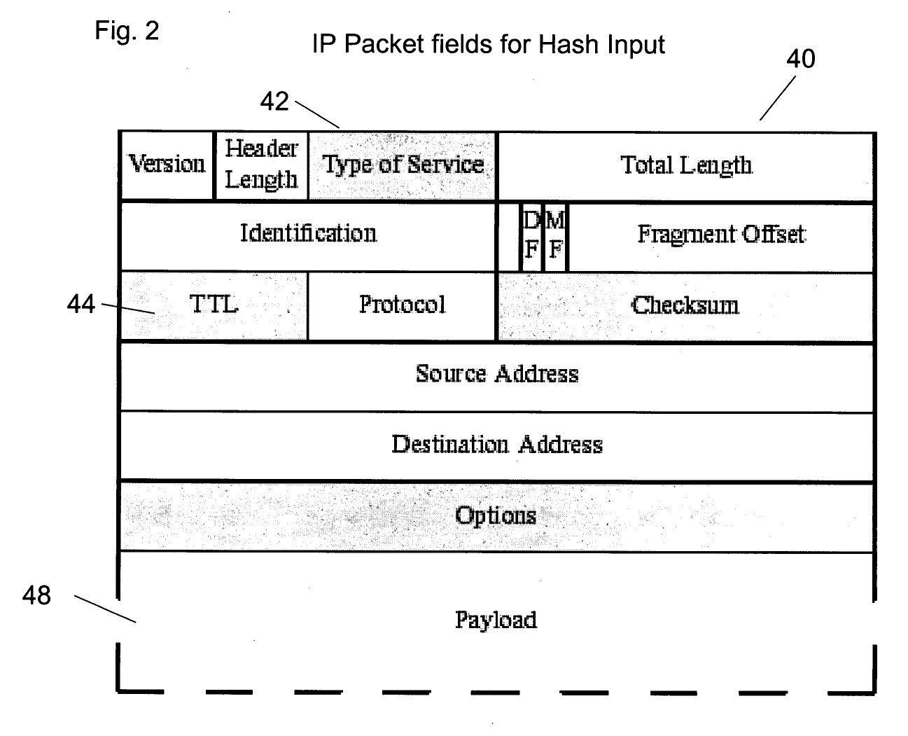

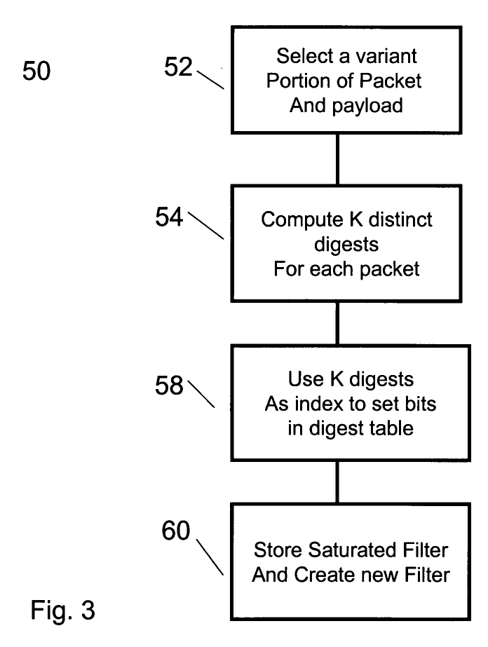

FIGS. 2 and 3 depict in more detail one such process for using hash digests to generate representations of the packets having passed through a router or otherwise observed by a device. Specifically, FIG. 2 depicts an exemplary data packet 40 of the type commonly forwarded over a data network. Portions of the data packet are well suited for using as input to a digest function as these portions allow for uniquely representing the data packet or at least providing sufficient uniqueness for the auditing application. FIG. 2 depicts that the packet 40 has certain fields that can be used in the digest operation employed by the modified router. In this example, the fields selected for use include the portions of the header such as the type of service 42 and the time to live (TTL) 44, as well as some portion of the payload 48—such as the first 8 bytes. These fields can be used to generate a digest that differentiates the processed packets from other data packets being passed over the network.

Once the portion of the data packet to be processed is selected, the process may then apply a hash function to the selected portion. A hash function is generally a mathematical function that maps values from one domain or set, to another domain or set wherein the later domain or set may optionally be smaller. This thereby provides the ability to reduce a potentially long message into a hash value that is usefully smaller. Optionally, hash functions can also distribute data from the first set somewhat more evenly over the second space. This is particularly helpful when the data packets being hashed are highly correlated. Thus, a hash function may process the selected data from the data packet by mapping the data string provided from the selected data to a perhaps smaller data string, thereby further reducing the amount of data required to record that the data packet was observed by the device.

The hash function employed by the device may vary according to the application, however, in certain embodiments it is preferred to use hash functions that have certain characteristics. One family of hash functions includes the universal hash family described by Carter and Wegman, see Carter et al. Universal Classes of Hash Functions, Journal of Computer and System Sciences, pp 143-154, 1979. However, other hash functions may be employed and the systems and methods described herein are not dependent upon any particular type of hash function and the hash function selected may vary according to the application. For example, other hash functions, which may be used in conjunction with the matter disclosed herein, can be found in Cryptography And Network Security Principles And Practice, Stallings, Prentice Hall (2000) and an example of a useful hash function that can be used with the invention is the Cyclical Redundancy Check (CRC). In any case, once the hash functions have been selected, the routers may include processes that generate hashes of the data packets it observed. Modifying a router to record information about observed packets after computing a hash value provides an efficient method for retaining unique information about each packet seen, or observed, by a participating router. Techniques and devices for quickly computing hash values are readily available and they can be implemented in the processing hardware and/or software currently used in routers without unduly reducing performance of the forwarding engines within the routers. Employing hash values significantly reduces the memory requirements for storing information about packets, and storage memory for these hashes can be added to the routers. The amount of memory needed depends upon the period of time over which data is being recorded, the number of data packets that may pass through the router during that time period, the size of the hash and any header information associated with the hash, such as a time stamp or an identifier for the device. Those of ordinary skill in the art will know how to modify the router to record this hash data, and any suitable hardware, software or a combination thereof may be used.

Thus, the recording routers can store information about the data packets it has processed, and this data may be used by the auditing server 24 to audit the data routes. The ability to accurately audit the routes turns on the recorded data being accurate and sufficient to identify whether a router has observed a particular packet. In one practice, the hash function selected produces a hash value that is unique for each input block of data, and therefore serves as a signature for the data over which it was computed. For example, incoming packets varying in size from 32 bits to 1000 bits could have a fixed 32-bit hash value computed over their length, with that value being unique for that data packet. Furthermore, the hash value may be computed in such a way that it is a function of all of the bits making up the input data, or alternatively it can be computed over a portion of input data. When used, a hash value essentially acts as a fingerprint identifying the input block of data over which it was computed. However, unlike fingerprints, there is a chance that two very different pieces of data will hash to the same value, i.e. a hash collision. An acceptable hash function should provide a good distribution of values over a variety of data inputs in order to prevent these collisions. Since collisions occur when different, i.e. unique, input blocks result in the same hash value, an ambiguity arises when attempting to associate a result with a particular input. This tendency for a hash function to cause collisions increases as it tries to reduce the amount of data used to represent the input data. However, data reduction is desirable as it reduces the amount of memory required to audit data traffic over a certain time period.

Thus, in one alternate practice the auditing processes apply hash functions to a portion of the data packet to reduce the amount of data needed to be recorded. In a further optional practice, the hash values are further processed to create a more space-efficient record of the observed data packets. Specifically, as described in detail in the above cited Snoeren et al, Single-Packet IP Traceback, multiple hash values may be computed for an observed data packet, with each hash value being compiled by an independent hash function. The multiple hash values (digests) may be used to index into an array that has been initialized with all zeros. Bits in the array are set to one in response to a digest pointing to that bit in the array.

Membership tests can be conducted by computing for a data packet of interest the multiple hash values and checking for each of these values whether the corresponding bit in the array is set. If any bit is zero, the packet was not observed by the device. If all bits are set, it is highly likely the packet was observed. Some false positives can arise, but these can be controlled by only allowing an array to store data associated with a limited number of digests. Saturated arrays can be swapped out with new ones. These index arrays are known as bloom filters and provide for substantial data compression for recording observations of data packet traffic.

FIG. 3 depicts a flow chart diagram of the hashing and indexing process described above for recording observations of data packets. Specifically, FIG. 3 depicts a process 50 that begins in a step 52 where process selects a variant portion of a data packet. As described with reference to FIG. 2, the process 50 will select portions of the data packet 40 that will vary from packet to packet. This provides input data to the process 50 that can be used to generate a unique or substantially unique record of a particular data packet. In step 54, the process 50 computes K distinct hash values (digests) for each packet. In step 58, the hash values computed in step 54 are used as index pointers to set bits in a digest table. In optional step 60, the process 50 after a certain point, the digest table may be deemed saturated and replaced with a new table or array, wherein all the bits in the table or array are initialized to zero.

The process of FIG. 3 may be implemented by each of the routers 22a-22e in the network 14, thereby creating a record of the data packets observed by the routers. Optionally, the routers may record over synchronized time periods, such as in response to a synch signal generated by the auditing server 24. In any case, collectively the routers 22a-22e contain a record of the routers that have processed each data packet that has traversed the network 14.

The auditing server 24 may use this record to determine the path over which a data packet of interest was routed. To this end, the auditing server 24 in one practice may send query messages to each router 22a-22e, directing each respective router to deliver its respective digest table for examination by the auditing server 24. Alternatively, the auditing server 24 may send a query message that includes a copy of the data packet of interest, along with an instruction that directs the router to determine whether the respective router observed the data packet of interest.

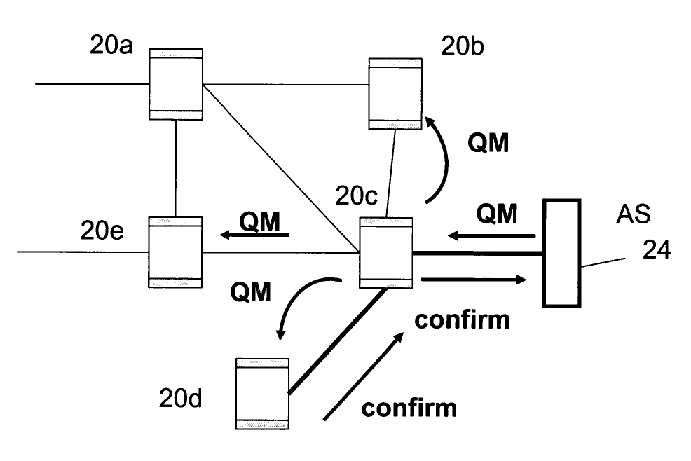

Thus, the auditing server 24 may detect a data packet of interest, and then generate a query message containing a copy of that data packet. After generating the query the auditing server 24 sends it to all routers located one hop away. This process is depicted pictorially in FIG. 4. When the router receives the query message from the auditing server 24, it determines if the data packet contained in the query message has been observed. This determination is made by hashing the data packet contained in the query message and comparing the resulting hash value, or digest, to a bit map of hash values representative of packets having previously passed through that router. The router is considered to have observed, or encountered, a packet when the packet is passed from one of the input ports to one of the output ports such as would be done when the router forwards, or propagates, a packet during normal operation within a network.

If the router has not observed the data packet, it may optionally so inform the auditing server 24. But if the router has a hash matching the data packet, it may send a response to the auditing server 24 indicating that the packet was observed by, or at, the router. This is depicted in FIG. 4 which illustrates the auditing server 24 sending a query message (QM) to the router 22c, which is one hop away. As the auditing server 24 may have observed a data packet that is only part way through its path, the auditing server 24 may send queries both upstream and downstream, to find the routers that observed the data packet of interest. In this example, the router 22c determines that it has seen the data packet of interest, and sends a reply confirming this to the auditing server 24. In addition, the router 22c may forward the query message to adjacent routers that are one hop away. In this fashion, the query message/reply process is forwarded to virtually all routers within a network on a hop-by-hop basis. As shown in FIG. 4, each router that has seen the data packet of interest, such as router 22d, sends a reply back to the auditing server 24, confirming the observation.

If routers external to the network 14 have not been configured to operate as modified recording routers, like routers 22a-22e, then the query message/reply process stops at the network border. But if the public network routers are configured to act as recording routers then the query message/reply process may continue. Overtime, the auditing router will receive a reply from each recording router and the data may be analyzed to determine the path through the network that the data packet of interest was actually observed to take.

As the auditing server 24 analyzes the data it may be several optional observed paths emerge as a result of hash collisions occurring in the participating routers. When hash collisions occur, they act as false positives in the sense that the auditing router 24 interprets the collision as an indication that the data packet of interest has been observed. Fortunately the occurrences of hash collisions can be mitigated. One mechanism for reducing hash collisions is to compute large hash values over the packets since the chances of collisions rise as the number of bits comprising the hash value decreases. Another mechanism for reducing collisions is to control the density of the hash tables in the memories of participating routers. That is, rather than computing a single hash value and setting a single bit for an observed packet, a plurality of hash values are computed for each observed packet using several unique hash functions. This produces a corresponding number of unique hash values for each observed packet. While this approach fills the hash table at a faster rate, the reduction in the number of hash collisions makes the tradeoff worthwhile in many instances. For example, bloom Filters may be used to compute multiple hash values over a given packet to reduce the number of collisions and hence enhance the accuracy of traced paths. Therefore, the disclosed invention is not limited to any particular method of computing hash functions nor is it limited to a particular type of source path localization algorithm or technique.

Additionally, as the auditing server 24 analyzes the returned data, collisions may be detected and removed from consideration by looking at the topography of the observed path and identifying singularities in the path. These singularities may be for example, recording routers that indicate an observation of the data packet of interest, but that are themselves disconnected from other routers having observed the data packet of interest. These isolated recording routers are likely reporting a collision and can be removed from consideration, or retested by auditing the paths of other similar data packets.

The auditing router 24 may process the recorded data to generate an observed path representative of the routers, links and devices that were observed to actually have carried or seen the data packet during its travel across the network. This observed path may then be compared to the expected path to determine whether deviations exist and whether there are deviations from the routing protocols that require corrective action or further investigation. For example, in one practice, the auditing router reviews the protocols of the routers in the network or internetwork being audited and determines an expected path for the data packet of interest. Therefore, if the routers in the network follow a Distance Vector routing protocol, the auditing router 24 can collect the distance data advertised by the routers in the network to determine for the particular packet of interest, its expected path through the network. Similarly, for routers that employ the Path Vector routing protocol, the advertised information may be collected and processed and employed to determine and expected path for a data packet. Other protocols may also be analyzed to determine an expected path for a data packet. For example, for routers that employ the Link state routing protocol, the auditing server 24 can collect the relevant information (usually known as Link State Advertisements) and compute the expected path. Additionally, in certain practices the expected path may be determined empirically by sending probe packets, stochastic analysis of the network traffic, or by any other suitable technique. Techniques and process for creating tables that may be employed to determine an expected path are discussed in the art, including in, for instance, section 2 of Chapter 12 of Radia Perlman, “Interconnections, 2nd edition” for how to build a network map from link state advertisements; similarly for vector protocols, see for instance, Chang et al, “Toward capturing representative AS-level Internet topologies” in Computer Networks 44(6): 737-755 and Gao “On inferring autonomous system relationships in the Internet”, IEEE/ACM Trans. on Networking 9(6):733-745. Additionally, it shall be understood that in certain embodiments and practices, the network topology of interest and/or the models and tables for determining an expected path, as well as the expected path itself, may be provided from a third party source or service. For example, the Route Views project from the University of Oregon provides topologies in a manner suitable for use with the systems and methods described herein, although any similar service may be used. In any case, the process will develop or obtain a model or models of how data is expected to pass through the network when each device in the network is operating in a manner that complies with its stated protocol. It is these models that can be compared to the observed path to find deviations from the expected.

These deviations may arise from the routers being intentionally corrupted to lie about both themselves and about what they have heard from other routers on the network. Deviations can arise in many different forms, and the actual deviations for which the auditing system is seeking may vary according to the application. However, some examples of deviations that may be deemed to indicate a need for corrective action include observing the data packet passing through a device that is not in the expected path; failing to observe the data packet pass through a device that is on the expected path; observing the data packet passing through a device that is on the expected path, but passing through that device in an order different from the sequence in the expected path, observing a packet being copied and copies being sent over paths other than the expected path (while the original continues on the expected path), and other similar deviations. Additionally, as the auditing system described herein may include recording routers that time stamp the data being digested, deviations may further include unexpectedly long delays and similar abnormalities. Additionally and optionally, the auditing server 24 may include a data packet generator that will generating a data packet to be forwarded over the network for auditing its expected path. Thus, the data packet generator can create a data packet as a function of the expected path of the data packet and send it over the network 10. The auditing server 24 may then query the devices expected to handle the packet, or alternatively perform the query process described above, to determine the observed path of that packet. In this way, the system may test and probe for compliance of one or more of the devices on the network, or for a region or portion of the network.

Once a deviation is identified, the auditing server 24 may optionally signal the isolation server 28 to take a corrective action. Such action can include removing any non-compliant device from the network from the routing tables of the other devices in the network. Alternatively, the isolation server 28 can flag an alarm for the network administrator, or attempt to deactivate the non-complying device. In cases where it is not possible to remove or deactivate or repair the non-complying device or devices, it may be possible to re-route data packets for particular traffic streams around the non-complying devices using well-known techniques such as static routes and tunnels.

From the above description, one can see a packet logging technique for auditing how data packets are routed over a data network. The systems and methods above provide for a reduced data recording and maintain the privacy of data traveling over the network. The invention, in one embodiment, provides an auditing system that requires only very few bits (3 to 5) to be stored for each datagram and that solves the storage problem such that given an average packet size of 1000+ bits, the overhead is less than 0.5% of the traffic bandwidth. It also solves privacy issues in those embodiments that use a one-way hashing function, such as the bloom filter which is not invertible.

The depicted systems can be achieved by using and modifying conventional data processing systems and routers. In fact, in one optional embodiment, the systems and methods described herein may employ a traffic sampling process of the type provided in commercially available routers, such as the NetFlow process available from Cicso Systems, Inc. of San Jose Calif.

As known to those of skill in the art, NetFlow and similar products, provide a set of services for IP applications, including network traffic accounting, usage-based network billing, network planning, security, Denial of Service monitoring capabilities, and network monitoring. NetFlow thus offers a traffic sampling scheme implemented in Cisco routers. In this optional embodiment of a routing auditing process and system, misrouted traffic is detected using statistics that routers keep using NetFlow.

NetFlow provides a statistically complex system, but the core idea is simple. Each interface on a router, such as routers 20a-20e depicted in FIG. 1, keeps a table of traffic flows, where a flow is understood by source and destination address, protocol number [e.g. UDP or TCP], and source and destination ports. Every time an interface receives a packet, it looks up that packet's flow in the flow table. If the table already has a record for the flow, the flow record is updated to show more data has passed through the router. If there is no record, a new record is created and a timestamp records when the flow was first seen. If a flow is idle for a certain period of time it is deemed to have closed, and the record is sent to a computer near the router for recording. If every packet is captured and recorded, NetFlow records, for each flow, when it starts, approximately when it ends, and how much data passed through. However, as discussed above, in practice, modern high speed routers will prefer not and many times can not afford, to record information about every packet it passes or processes. Thus, routers 20a-20e may sample the incoming data, by examining every N^{th} packet, N being typically large although this can vary given the application at hand, and recording its information in the flow table.

There are measurement issues that may occur when sampling only every N^{th} packet as opposed to recording information about each packet, but for the purposes of this study there is one significant issue: the system no longer knows about every packet, and it no longer knows about every flow; especially if flows are small, this sampling process means that some flows may never get noted. However, even given these issues, the sampling systems and methods may audit routing protocols as described below.

In one practice, the process starts with the assumption that N=1; that the auditing system sees every packet in every flow. Then, given the graph of how it is expected to see data routed, the auditing server 24 can sample the NetFlow data from each participating router, or from selected routers, and see if each flow is where it is supposed to be. In other words, suppose the auditing server 24 sees a flow from source A to destination B at router 20d, on interface R1. The auditing server 24 may observe the graph and see whether traffic from A to B is expected to flow through router 20d; and if traffic from A to B is expected to arrive on interface R1. Given this process, the sampling auditing server would detect misdirections of data, even single packets. It also may detect duplication, depending on whether all duplicate packets arrived at the same interface.

However, the effects of sampling will cause a less complete analysis of data flow. There is only a 1 in N chance of detecting the misdirection of a single packet in a particular router. There is about a 1 in N2 chance of detecting both a packet and its duplicate, assuming they arrive on separate interfaces in the router. Both these probabilities get lowered the farther the misdirected or duplicate packets proceed in the network. But recall that N is typically large, so the chance of missing misrouting is also typically large. Thus, in certain practices the value of N may be selected, at least in part, to meet an acceptable level of data packet flow monitoring. An additional concern is the need for securing the NetFlow data. Often, data is sent unreliably (via UDP) to collection systems such as the auditing server 24 and, may not be digitally signed. So not only can a malevolent router lie about its NetFlow statistics—but it can suppress or alter the NetFlow reporting datagrams that pass through it. Thus, in further optional embodiments, the system 10 will employ secure methods for transmitting Flow reports, and may include verification processes for ensuring that the data received from a router is valid and truthful. Thus, it will be apparent to one of ordinary skill in the art, that the auditing server 24 can comprise conventional commercially available computer hardware and software that becomes configured according to the systems of the invention by the operation of computer software that configures the conventional computer hardware and software to operate as systems according to the invention.

Accordingly, although FIG. 1 graphically depicts the auditing system as functional block elements, it will be apparent to one of ordinary skill in the art that these elements can be realized as computer programs or portions of computer programs that are capable of running on the data processor platform to thereby configure the data processor as a system according to the invention. Moreover, although FIG. 1 depicts the auditing system 24 and the isolation server as separate elements, it will be apparent to those or ordinary skill in the art that this is only one embodiment, and that the invention can be embodied as a computer program that can operate on a single server.

Other variations on the auditing system are also possible. For instance, not all links need to be monitored or observed. In the situation where only some links are observed, we can still see if packets arrive on monitored links or pass through monitored routers in the order they would use if following the expected path (or more generally, we can audit parts of the expected path—we need not audit all of the path).

In an alternate variation, the information about where the data packet passed is stored not in monitoring devices or routers, but in the data packet itself. There are a number of widely known methods for embedding path information into otherwise unused bits of the data packet header. A monitoring device can record this path information from passing data packets and use the path information to reconstruct the path over which packets travel.

As discussed above, the auditing system, including routers, auditing server and isolation server, can be realized as software components operating on a conventional data processing system such as a Unix workstation. In that embodiment, the devices can be implemented as a C language computer program, or a computer program written in any high level language including C++, Fortran, Java or basic. General techniques for high level programming are known, and set forth in, for example, Stephen G. Kochan, Programming in C, Hayden Publishing (1983). The data tables may be any suitable database system, including the commercially available Microsoft Access database, and can be a local or distributed database system. The design and development of suitable database systems are described in McGovern et al., A Guide To Sybase and SQL Server, Addison-Wesley (1993).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

I claim:

1. A method for auditing how a network routes a data packet, comprising
identifying a data packet of interest,
obtaining an expected path that the data packet of interest is expected to follow through the network,
using information recorded by devices in the network to observe the path the data packet of interest actually takes through the network, and
comparing the observed path to the expected path.

2. A method according to claim 1, wherein identifying a data packet of interest includes tapping the network and monitoring data packets moving across the network.

3. A method according to claim 1, wherein using information includes providing devices for recording information representative of data packets moving over a link in the network.

4. A method according to claim 3, wherein providing devices includes providing bloom filters for generating reduced data size representations of observed data packets.

5. A method according to claim 3, wherein
providing devices for recording includes providing means for generating a hash value from at least a portion of a data packet.

6. A method according to claim 1, further comprising
providing a query message to devices on the network for directing the devices to indicate whether the devices observed the data packet of interest.

7. A method according to claim 1, further comprising
providing a query message to devices on the network for directing the devices to provide data representative of data packets observed by the respective device.

8. A method according to claim 1, further comprising
generating a graph representative of the route through the network taken by the data packet of interest.

9. A method according to claim 1, wherein comparing includes
comparing the devices that were observed to pass the data packet of interest with the devices that were expected to pass the data packets of interest and identifying a non-compliant device passing the data packet of interest in a manner inconsistent with the determined protocol.

10. A method according to claim 9, further comprising
taking corrective action to prevent the non-compliant device from receiving data packets.

11. A method according to claim 10, wherein corrective action includes action selected from the group consisting of removing a non-compliant device from the network from the routing tables of other devices in the network, generating an alarm, deactivating a non-complying device and re-routing data packets for particular traffic streams around a non-complying devices.

12. A method according to claim 1, wherein
using information provided from devices includes using information from devices selected from the group consisting of routers, gateways, bridges, switches, concentrators and repeaters.

13. A method according to claim 1, wherein obtaining an expected path includes deriving the expected path from information provided by the network.

14. A method according to claim 1, wherein obtaining an expected path includes obtaining the information used to determine the expected route from a party managing or monitoring the network.

15. A method according to claim 1, wherein the devices in the network record path information in the data packets of interest, and this information is retrieved by other devices later in the path.

16. A method according to claim 1, wherein the observed path includes only parts of the path actually taken by the data packet of interest, and these parts are compared against corresponding parts of the expected path.

17. In a network comprising a plurality of devices for facilitating the transmission of data packets, a system for auditing data packet routing processes to identify a non-compliant device, comprising
an auditing system using information recorded by devices in the network for observing a route of a data packet of interest carried over the network, and
an isolation system responsive to the auditing system for comparing an observed route of the data packet of interest with an expected route and identifying whether a non-compliant device has passed the data packet of interest in violation of protocol.

18. The system of claim 17, wherein
the auditing system includes means associated with the plurality of devices for generating a hash representative of the data packets observed by respective ones of the devices.

19. The system of claim 18 further including a bloom filter for processing portions of a data packet.

20. The system of claim 17, wherein the auditing system includes a query process for generating query messages that direct devices on the network to indicate whether they have observed a data packet of interest.

21. The system of claim 17, wherein the devices on the network include a processor for generating query messages that direct other devices on the network to indicate whether they have observed a data packet of interest.

22. The system of claim 17, wherein the auditing system includes a process for generating an observed path representative of at least a portion of the path across the network that the data packet was observed to take.

23. The system of claim 17, wherein the isolation system generates for a data packet being carried on the network, and as a function of determined protocols for devices on the network, an expected route table representative of the devices on the network that are expected to pass the data packet according to the determined protocol.

24. The system of claim 17, wherein the isolation system includes a process for comparing an observed route of a data packet with an expected route for the data packet and identifying whether a non-compliant device has passed a data packet in violation of protocol

25. The system of claim 17, wherein the isolation system identifies a non-compliant event upon determining an event selected from the group consisting of determining a device expected to pass a data packet of interest has failed to pass the data packet of interest, determining a device not in the expected path has received the data packet of interest and determining a sequence of devices is an expected path differs from a sequence of devices in an observed path.

26. The system of claim 17, further comprising
a monitoring system for detecting a data packet associated with a selected conversation or flow.

27. The system of claim 17, further including
a data packet generator for generating a data packet to be forwarded over the network for auditing its expected path.

28. The system of claim 27, wherein
the data packet generator generates the data packet as a function of the expected path of the data packet for probing compliance of one or more selected devices on the network.

29. The system of claim 28, further comprising
means for processing a sampled data flow provided from a router for auditing the routing of data packets through the network.
